(19) United States
(12) Patent Application Publication
(10) Pub. No.: US 2020/0158504 A1
(43) Pub. Date: May 21, 2020

(54) LASER GRADING SYSTEM

(71) Applicant: ISMAEL MEDINA, VINELAND, NJ (US)

(72) Inventor: ISMAEL MEDINA, VINELAND, NJ (US)

(21) Appl. No.: 16/198,564

(22) Filed: Nov. 21, 2018

(51) Int. Cl. G01C 15/00

(52) U.S. Cl. CPC G01C 15/004

(57) ABSTRACT

A laser grading system that includes: a laser housing, where the laser housing includes a laser output and a housing base; a height adjustment bracket extending from the housing base; and a surface base, wherein the surface base joins with the housing base. The laser grading system may further include a first lever adapted to attach the height adjustment bracket to the housing base and a second lever adapted to attach the height adjustment bracket to the surface base. A level may be integrated into the laser housing. Further, a first ruler and a second ruler may be used in conjunction with the laser housing.

### BACKGROUND OF THE INVENTION

### Field of Invention

The present invention relates to a laser grading system that includes a laser housing used in conjunction with attachable rulers.

### Description of Related Art

In the construction industry, grading is a common task that is required to establish a level surface area. It is important to have a level surface area to ensure an accurate starting point for any further construction on the target surface. Grading is used both in roadway and building construction and it is important to have suitable grading established for installation of various building components and surfaces.

The typical grading process includes the use of a string mounted and used to create accurate grading level by the technician. This tried and true grading method does become time consuming. The grading process involves tying off a string and then retying off the string as needed as positions are changed over a particular surface. It is therefore advantageous to implement a laser system that may effectively replace the string leveling system of the prior art.

### SUMMARY OF THE INVENTION

The present invention relates a laser grading system that includes: a laser housing, where the laser housing includes a laser output and a housing base; a height adjustment bracket extending from the housing base; and a surface base, wherein the surface base joins with the housing base. The laser grading system may further include a first lever adapted to attach the height adjustment bracket to the housing base and a second lever adapted to attach the height adjustment bracket to the surface base. A level may be integrated into the laser housing. Further, a first ruler and a second ruler may be used in conjunction with the laser housing.

### BRIEF DESCRIPTION OF DRAWINGS

FIG. 1 depicts a laser grading system according to our present invention.

### DETAILED DESCRIPTION

The present invention relates to a laser grading system that is used to grade surface area for construction purposes. The grading system according to the present invention includes a surface base that is connected to a laser housing via a height adjustable bracket. As configured, the base is placed on the target surface or ground and the height adjusted through the use of the bracket that is connected to a housing base into the surface base through connectors. The laser housing further includes a laser output and a means to attach a ruler to a curb pin. Further, an attachment provided on the laser housing will attach to the curb pin.

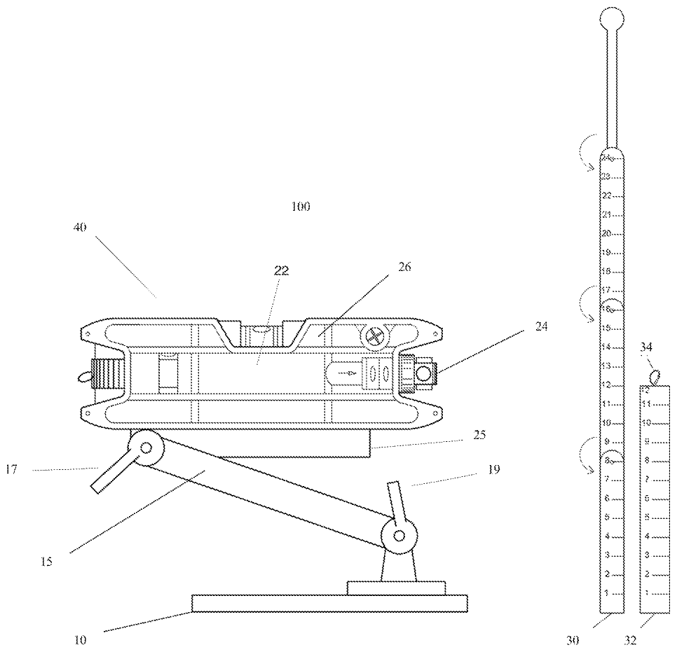

In reference to FIG. 1, the laser grading system 100 is shown and depicted. This laser grading system 100 as shown includes a base 10 that provides the overall support of the laser housing 40. The laser housing 40 is connected to base 10 through the use of a height bracket 15 that has a first lever 17 connecting to a housing base 25. The second lever 19 connects to base 10 that enables height adjustment for the laser housing 40.

Other features of the laser housing 40 include a laser output 24 at a first end of the laser housing 40 and a curb pin attachment 22 at a second end of the laser housing 40. The laser housing 40 further includes a level 26 where the level 26 provides a bubble level used to level the horizontal position of the laser emitting from the laser output 24. The adjustment of the laser housing 40 is accomplished by using the first lever 17 that attaches to the height bracket 15 to housing base 25. This first lever 17 is used in conjunction to the second lever 19 to position the laser 40 at appropriate height. The curved pin attachment 22 may be used in conjunction with a second ruler 32 also shown in FIG. 1. A first ruler 30 and a second ruler 32 are used in conjunction with the laser system according to the present invention.

The base 10 and height bracket 15 are made of heavy solid material with sufficient weight to keep the laser housing 40 in a stationary position. Once locked into place with the first lever 17 and second lever 19, the laser housing 40 is appropriately positioned for grading purposes. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use.

What is claimed is:

1. A laser grading system comprising:
a. a laser housing, where the laser housing includes a laser output and a housing base;
b. a height adjustment bracket extending from the housing base; and
c. a surface base, wherein the surface base joins with the housing base.

2. The laser grading system according to claim 1, where a first lever attaches the height adjustment bracket to the housing base and a second lever attaches the height adjustment bracket to the surface base.

3. The laser grading system according to claim 1, further including a level on the laser housing.

4. The laser grading system according to claim 1, further including a first ruler and a second ruler used in conjunction with the laser housing.
